(19) United States
(12) Patent Application Publication
(10) Pub. No.: US 2007/0022451 A1
(43) Pub. Date: Jan. 25, 2007

(54) Broadcasting receiving/transmitting device, wireless A/V system and control method of wireless A/V system

(75) Inventors: Kab-keun Lee, Suwon-si (KR); Bong-geun Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/472,299

(22) Filed: Jun. 22, 2006

(30) Foreign Application Priority Data
Jul. 25, 2005 (KR) 2005-0067550

(51) Int. Cl. H04N 7/173; G06F 3/00; G06F 13/00; H04N 5/445

(52) U.S. Cl. 725/86; 725/87; 725/37; 725/39; 725/61

(57) ABSTRACT

A broadcasting receiving/transmitting device for encoding a broadcasting signal in an encoding format and transmitting it to an external device by wireless transmission is provided which includes a broadcasting signal processor for encoding the broadcasting signal according to the encoding format and outputting it, a wireless module for transmitting the broadcasting signal encoded through the broadcasting signal processor to the external device by wireless transmission, and a controller for detecting EPG information from the broadcasting signal, generating an EPG menu data based on the detected EPG information and controlling the broadcasting signal processor so as to encode at least one of the EPG menu data and the broadcasting signal according to the encoding format to thereby be transmitted to the external device via the wireless module of the transmitting side. Also, a broadcasting receiving/transmitting device, a wireless A/V system and a control method of a wireless A/V system are provided to transmit an EPG menu data and/or an EPG debugging signal which are generated on EPG information by wireless transmission via an A/V signal area, thereby solving an error caused by transmitting the EPG menu data and/or the EPG debugging signal and achieving two-way communication of the EPG debugging signal.

### CROSS-REFERENCE TO RELATED APPLICATIONS

This application claims the benefit under 35 U.S.C. §119(a) of Korean Patent Application No. 2005-0067550, filed on Jul. 25, 2005, in the Korean Intellectual Property Office, the entire disclosure of which is hereby incorporated by reference.

### BACKGROUND OF THE INVENTION

1. Field of the Invention

The present invention relates to a broadcasting receiving/transmitting device, a wireless audio/video (A/V) system and a control method of a wireless A/V system. More particularly, the present invention relates to a broadcasting receiving/transmitting device, a wireless A/V system and a control method of a wireless A/V system capable of transmitting Electronic Program Guide (EPG) menu data which is generated on EPG information and/or an EPG debugging signal, by wireless transmission via an A/V signal area.

2. Description of the Related Art

There are now widely used wireless A/V systems which transmit image and audio data by wireless transmission, that is, without connecting A/V apparatuses by wire.

FIG. 1 shows an example of a conventional wireless A/V system. The conventional wireless A/V system comprises a broadcasting receiving/transmitting device 110 and a wireless receiving device 120 provided with a broadcasting signal from the broadcasting receiving/transmitting device 110 by wireless transmission.

The broadcasting receiving/transmitting device 110 comprises a tuner 112, a digital processor 113, a moving picture exports group (MPEG) encoder 115, a wireless module of a transmitting side 116 and a controller 117.

The tuner 112 receives an RF signal of a broadcasting signal and tunes at least one channel of the received broadcasting signal according to control by the controller 117. The digital processor 113 converts the analog broadcasting signal into digital data.

The MPEG encoder 115 encodes digital data in an MPEG encoding format and outputs it so that the digital data output from the digital processor 113 is transmitted by wireless transmission via the wireless module of the transmitting side 116.

The wireless module of the transmitting side 116 transmits the data encoded by the MPEG encoder 115 by wireless transmission.

The wireless receiving device 120 comprises a wireless module of a receiving side 126 and an MPEG decoder/controller 127.

The wireless module of the receiving side 126 receives the data transmitted via the wireless module of the transmitting side 116 of the broadcasting receiving/transmitting device 110 and provides it to the MPEG decoder/controller 127.

The MPEG decoder/controller 127 decodes the data received via the wireless module of the receiving side 126, converts it into an image or an audio format signal, and then outputs it. In this case, the image signal is provided to a display unit 129 to display an image and the audio signal is provided to an amplifier (not shown) to express a sound.

The controller 117 of the broadcasting receiving/transmitting device 110 detects EPG information in a vertical blanking interval (VBI) of the broadcasting signal. Further, the controller 117 generates the EPG menu data based on the detected EPG information and transmits the EPG menu data to the wireless receiving device 120 via the wireless module of the transmitting side 116 when a user selects to display the EPG menu. The MPEG decoder/controller 127 converts the EPG menu data received via the wireless module of the receiving side 126 in a format to be displayed on the display unit 129.

Here, transmitting/receiving the data by wireless transmission between the wireless module of the transmitting side 116 of the broadcasting receiving/transmitting device 110 and the wireless module of the receiving side 126 of the wireless receiving device 120 is performed in different areas, that is, an A/V signal area and a user data area, according to the kind of data transmitted.

The A/V signal area is where the encoded data, for example A/V data output from the MPEG encoder 115 of the broadcasting receiving/transmitting device 110, is transmitted. The user data area is where data other than the A/V data is transmitted/received. Accordingly, EPG data is transmitted via the user data area. Such EPG data includes the EPG menu data and an EPG debugging signal for debugging the EPG transmitted via a debugging signal transmitting/receiving part 118 from the broadcasting receiving/transmitting device 110 to the wireless receiving device 120.

However, in the conventional wireless A/V system, if the EPG menu data has a higher transmission rate, for example, 1200 bits per second (bps), than a data transmission rate in the user data area, there is a possibility of failing to transmit the EPG menu data. Also, in case that a maximum transmission rate of the EPG debugging signal is 14400 bps or more, there is a possibility of failing to debug the EPG.

Currently, although a transmittance rate is assured to be enough in the user data area, e.g. 15800 bps, it is almost impossible to transmit the EPG debugging signal which requires two-way communication in real-time.

Accordingly there is a need for an improved broadcasting receiving/transmitting device, wireless system and control method capable of transmitting EPG information.

### SUMMARY OF THE INVENTION

Exemplary embodiments of the present invention address at least the above problems and/or disadvantages and provide at least the advantages described below. Accordingly, it is an exemplary aspect of the present invention to provide a broadcasting receiving/transmitting device, a wireless A/V system and a control method of a wireless A/V system which transmits an EPG menu data and/or an EPG debugging signal which are generated on EPG information by wireless transmission via an A/V signal area, thereby solving an error caused by transmitting the EPG menu data and/or the EPG debugging signal and achieving two-way communication of the EPG debugging signal.

The foregoing and/or other exemplary aspects of the present invention are achieved by providing a broadcasting receiving/transmitting device for encoding a broadcasting signal in an encoding format and transmitting it to an external device by wireless transmission, comprising: a broadcasting signal processor for encoding the broadcasting signal according to the encoding format and outputting it; a wireless module of a transmitting side to transmit the broadcasting signal encoded through the broadcasting signal processor to the external device by wireless transmission; and a controller detecting EPG information from the broadcasting signal, generating EPG menu data based on the detected EPG information and controlling the broadcasting signal processor so as to encode at least one of the EPG menu data and the broadcasting signal according to the encoding format to thereby be transmitted to the external device via the wireless module of the transmitting side.

According to an exemplary embodiment of the present invention, the broadcasting receiving/transmitting device comprises a tuner receiving the broadcasting signal; a digital processor converting the broadcasting signal received from the tuner into digital data; an encoder encoding the digital data from the digital processor according to the encoding format to be output; and a data selecting part inputting at least one of the EPG menu data and the digital data to the encoder according to control by the controller.

According to an exemplary embodiment of the present invention, the encoding format comprises an MPEG format.

According to an exemplary embodiment of the present invention, the broadcasting receiving/transmitting device further comprises a debugging signal transmitting/receiving part transmitting/receiving an EPG debugging signal for debugging an EPG; wherein the controller encodes the debugging signal received via the debugging signal transmitting/receiving part through the encoder to thereby be transmitted to the external device.

According to an exemplary embodiment of the present invention, a data transmitting area by wireless transmission between the wireless module of the transmitting side and the external device comprises an A/V signal area to transmit data which is encoded through the encoder and a user data area to transmit data other than data which is encoded through the encoder.

The foregoing and/or other exemplary aspects of the present invention are also achieved by providing a wireless A/V system comprising: the broadcasting receiving/transmitting device; and a wireless receiving device comprising a wireless module of a receiving side to transmit/receive data to the broadcasting receiving/transmitting device by wireless transmission and a decoder/signal processor decoding a broadcasting signal received through the wireless module of the receiving side, converting it to an image format signal and an audio format signal, and then outputting it.

The foregoing and/or other exemplary aspects of the present invention are also achieved by providing a data transmitting method of a wireless A/V system comprising a first device and a second device which transmit/receive data in an A/V signal area and a user data area, separately, comprising: receiving a broadcasting signal in the first device; detecting EPG information of the broadcasting signal; generating EPG menu data based on the EPG information; encoding at least one of the broadcasting signal and the EPG menu data according to an encoding format; and transmitting the encoded data through the A/V signal area from the first device to the second device.

According to an exemplary embodiment of the present invention, the encoding process according to the encoding format comprises selecting whether to display the EPG information; and encoding the EPG menu data according to the encoding format in case that it is selected to display the EPG information.

According to an exemplary embodiment of the present invention, the encoding format comprises an MPEG format.

According to an exemplary embodiment of the present invention, the data transmitting method of the wireless A/V system, further comprises receiving an EPG debugging signal for debugging an EPG in the first device; wherein the encoding process according to the encoding format further comprises encoding the EPG debugging signal according to the encoding format.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a control block diagram of a conventional wireless A/V system;

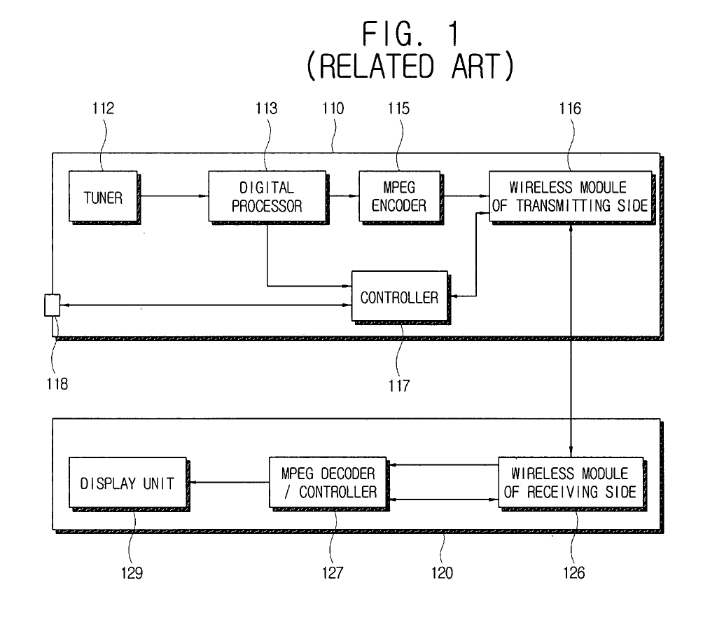

FIG. 2 is a control block diagram of a wireless A/V system according to the present invention; and

FIG. 3 is a flow chart of a broadcasting receiving/transmitting device according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Reference will now be made in detail to exemplary embodiments of the present invention, examples of which are illustrated in the accompanying drawings, wherein like reference numerals refer to like elements throughout. The embodiments are described below in order to explain the present invention by referring to the figures.

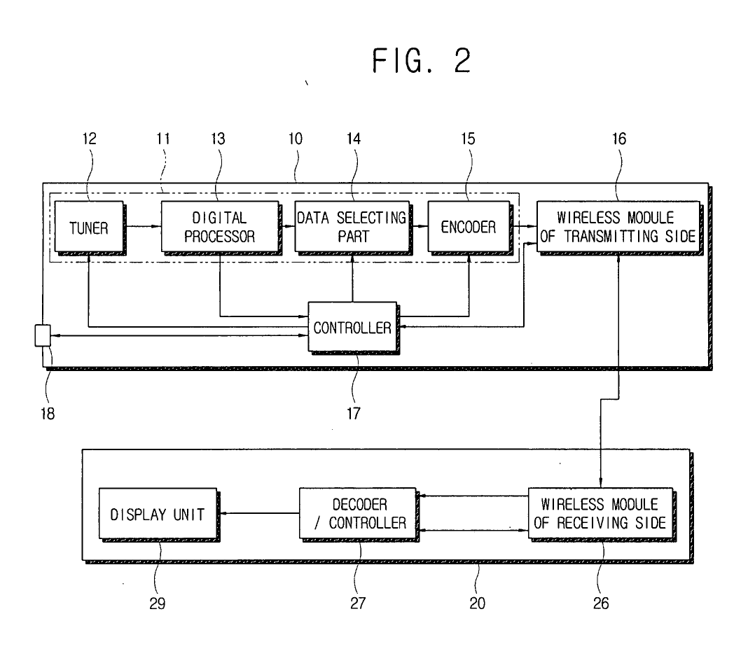

As shown in FIG. 2, a wireless A/V system comprises a broadcasting receiving/transmitting device 10 and a wireless receiving device 20.

The broadcasting receiving/transmitting device 10 comprises a broadcasting signal processor 11, a wireless module of a transmitting side 16 and a controller 17.

The broadcasting signal processor 11 encodes a broadcasting signal in an encoding format and outputs it to the wireless module of the transmitting side 16. Here, the broadcasting signal processor 11, according to an exemplary embodiment of the present invention, comprises a tuner 12, a digital processor 13, an encoder 15 and a data selecting part 14.

The tuner 12 receives an RF signal of a broadcast signal and tunes at least one channel of the received broadcast signal according to control by the controller 17. The digital processor 13 converts the analog broadcast signal into digital data.

The encoder 15 encodes the digital data in an encoding format so that the digital data output from the digital processor 13 is transmitted by wireless transmission via the wireless module of the transmitting side 16. For example, the encoder 15 encodes the digital data in an MPEG encoding format in the present invention.

The data selecting part 14 inputs at least one of the digital data output from the digital processor 13 and EPG menu data output from the controller 17 to the encoder 15 according to control by the controller 17.

Meanwhile, the wireless module of the transmitting side 16 transmits the data encoded by the encoder 15 of the broadcasting signal processor 11 by wireless transmission to a wireless module of a receiving side 26 of a wireless receiving device 20.

Transmitting/receiving the data by wireless transmission between the wireless module of the transmitting side 16 of the broadcasting receiving/transmitting device 10 and the wireless module of the receiving side 26 of the wireless receiving device 20 is performed in different areas, that is, an A/V signal area and a user data area, according to the kind of data transmitted.

The encoded data output from the encoder 15 of the broadcasting receiving/transmitting device 10 is transmitted to the wireless receiving device 20 via the A/V signal area. That is, the EPG menu data as well as the broadcast signal encoded in the encoder 15 of the broadcasting receiving/transmitting device 10 may be transmitted to the wireless receiving device 20 via the A/V signal area in an exemplary embodiment of the present invention.

The controller 17 detects EPG information of the broadcast signal received via the tuner 12. Furthermore, the controller 17 generates the EPG menu data based on the detected EPG information and outputs the generated EPG menu data to the encoder 15 when a user selects to display the EPG menu. Herein, the controller 17 may detect the EPG information in a VBI of the broadcasting signal.

The controller 17 controls the data selecting part 14 so that at least one of the digital data output from the digital processor 13 and the EPG menu data output from the controller 17 may be input to the encoder 15. In case that a user selects to display the EPG menu, the controller 17 controls the data selecting part 14 so that the EPG menu data is input to the encoder 15.

The wireless receiving device 20 comprises the wireless module of the receiving side 26 and a decoder/signal processor 27.

The wireless module of the receiving side 26 performs wireless data communication with the wireless module of the transmitting side 16 of the broadcasting receiving/transmitting device 10 via the A/V signal area and the user data area.

The decoder/signal processor 27 decodes the data received through the A/V signal area of the wireless module of the receiving side 26, converts the decoded data into an image or an audio format signal, and then outputs it. The image signal may be provided to a display unit 29 to display an image and the audio signal is provided to an amplifier (not shown) to express a sound.

At this point, the data received through the A/V signal area of the wireless module of the receiving side 26, which is a data encoded by the encoder 15 of the broadcasting receiving/transmitting device 10, corresponds to at least one of the digital data from the digital processor 13 and the EPG menu data from the controller 17.

In an exemplary embodiment, the broadcasting receiving/transmitting device 10 according to the present invention may further comprise a debugging signal transmitting/receiving part 18 to transmit/receive the EPG debugging signal for debugging the EPG. The controller 17 outputs the EPG debugging signal received via the debugging signal transmitting/receiving part to the encoder 15. Then, the EPG debugging signal is encoded by the encoder 15 and is transmitted to the wireless receiving device 20 via the A/V signal area of the wireless module of the transmitting side 16. Accordingly, a transmission rate is assured to be sufficient when the EPG debugging signal is transmitted between the broadcasting receiving/transmitting device 10 and the wireless receiving device 20, thereby allowing two-way communication in real-time.

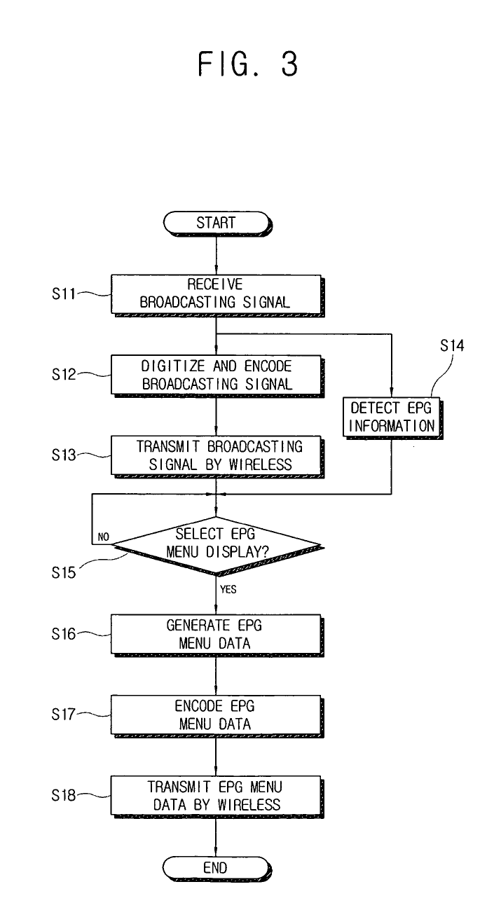

Hereinafter, a control process of the broadcasting receiving/transmitting device 10 of the wireless A/V system according to an exemplary embodiment of the present invention will be described with reference to FIG. 3.

First, when a broadcasting signal is received via the tuner 12 at operation S11, the broadcasting signal is digitized in the digital processor 13 and encoded in the encoder 15 at operation S12. The broadcasting signal is transmitted to the wireless receiving device 20 via the wireless module of the transmitting side 16 at operation S13. Meanwhile, the controller 17 detects EPG information of the broadcasting signal in the process of transmitting the broadcasting signal at operation S14.

While performing the aforementioned processes, the controller 17 determines whether display of an EPG menu is selected at operation S15. Herein, the display of the EPG menu is selected by, for example, a remote control device, or a selection button provided in the broadcasting receiving/transmitting device 10 or the wireless receiving device 20.

If the display of the EPG menu is selected, the controller 17 generates an EPG menu data based on the EPG information and outputs it at operation S16. Further, the controller 17 controls the data selecting part 14 so that the EPG menu data is input to the encoder 15 among the EPG menu data and the digital data output from the digital processor 13.

Thereafter, the encoder 15 encodes the EPG menu data according to an encoding format at operation S17 and outputs it to the wireless module of the transmitting side 16. The wireless module of the transmitting side 16 transmits the encoded EPG menu data to the wireless receiving device 20 at operation S18.

Accordingly, the decoder/signal processor 27 of the wireless receiving device 20 decodes the encoded EPG menu data received via the wireless module of the receiving side 26 and outputs it to the display unit 29, so that the EPG menu data is displayed on a screen.

Although exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A broadcasting receiving/transmitting device encoding a broadcasting signal in an encoding format and transmitting it to an external device by wireless transmission, comprising:
a broadcasting signal processor for encoding a broadcasting signal according to an encoding format and outputting it;
a wireless module to transmit the encoded broadcasting signal to an external device by wireless transmission; and
a controller detecting Electronic Program Guide (EPG) information from the broadcasting signal, generating EPG menu data based on the detected EPG information and controlling the broadcasting signal processor so as to encode at least one of the EPG menu data and the broadcasting signal according to the encoding format to be transmitted to the external device via the wireless module.

2. The broadcasting receiving/transmitting device according to claim 1, wherein the broadcasting signal processor comprises:
a tuner receiving the broadcasting signal;
a digital processor converting the broadcasting signal received from the tuner into digital data;
an encoder encoding the digital data from the digital processor according to the encoding format to be output; and
a data selecting part inputting at least one of the EPG menu data and the digital data to the encoder according to control by the controller.

3. The broadcasting receiving/transmitting device according to claim 2, wherein the encoding format comprises an MPEG format.

4. The broadcasting receiving/transmitting device according to claim 3, further comprising a debugging signal transmitting/receiving part for transmitting/receiving an EPG debugging signal for debugging an EPG;
wherein the controller encodes the debugging signal received via the debugging signal transmitting/receiving part through the encoder to thereby be transmitted to the external device.

5. The broadcasting receiving/transmitting device according to claim 4, wherein a data transmitting area by wireless transmission between the wireless module of the transmitting side and the external device comprises an A/V signal area to transmit data which is encoded through the encoder and a user data area to transmit data other than the data which is encoded through the encoder.

6. A wireless A/V system comprising:
a broadcasting receiving/transmitting device encoding a broadcasting signal in an encoding format and transmitting it to an external device by wireless transmission, comprising a broadcasting signal processor for encoding a broadcasting signal according to an encoding format and outputting it, a wireless module to transmit the encoded broadcasting signal to an external device by wireless transmission, and a controller detecting Electronic Program Guide (EPG) information from the broadcasting signal, generating EPG menu data based on the detected EPG information and controlling the broadcasting signal processor so as to encode at least one of the EPG menu data and the broadcasting signal according to the encoding format to thereby be transmitted to the external device via the wireless module; and
a wireless receiving device comprising a wireless module of a receiving side to transmit/receive data to the broadcasting receiving/transmitting device by wireless transmission and a decoder/signal processor decoding a broadcasting signal received through the wireless module of the receiving side, converting it to an image format signal or an audio format signal, and then outputting it.

7. A data transmitting method of a wireless A/V system comprising a first device and a second device which transmit/receive data using an A/V signal area and a user data area, separately, comprising:
receiving a broadcasting signal in the first device;
detecting EPG information of the broadcasting signal;
generating EPG menu data based on the EPG information;
encoding at least one of the broadcasting signal and the EPG menu data according to an encoding format; and
transmitting the encoded data through the A/V signal area from the first device to the second device.

8. The data transmitting method of a wireless A/V system according to claim 7, wherein the encoding process according to the encoding format comprises selecting whether to display the EPG information; and encoding the EPG menu data according to the encoding format in case it is selected to display the EPG information.

9. The data transmitting method of a wireless A/V system according to claim 8, wherein the encoding format comprises an MPEG format.

10. The data transmitting method of a wireless A/V system according to claim 9, further comprising receiving an EPG debugging signal for debugging an EPG in the first device; wherein the encoding process according to the encoding format further comprises encoding the EPG debugging signal according to the encoding format.
